(19) United States
(12) Patent Application Publication
(10) Pub. No.: US 2007/0087753 A1
(43) Pub. Date: Apr. 19, 2007

(54) Method for providing international calling services

(76) Inventors: Jay Rosenblatt, Bethesda, MD (US); John Melick, Aventura, FL (US)

Correspondence Address: PLUMSEA LAW GROUP, LLC, 10411 MOTOR CITY DRIVE, SUITE 320, BETHESDA, MD, 20817, US

(21) Appl. No.: 11/248,610

(22) Filed: Oct. 13, 2005

(51) Int. Cl. H04Q 7/20

(52) U.S. Cl. 455/445

(57) ABSTRACT

A method for providing international calling services is disclosed. The method begins by preparing a mobile device for communication with a first network. In some cases, this would include registering the mobile device with the first network. The mobile device is then exported to a foreign service provider located in a foreign country. A user brings the mobile device back into the domestic nation (for example, the United States) after having purchased or leased the mobile device from the foreign service provider. The method can assist with various functions of the mobile device including: receiving call records related to the usage of the mobile device, and efficiently routing international and domestic calls.

### BACKGROUND OF THE INVENTION

1. Field of the Invention

The present invention relates generally to communications, and in particular the present invention relates to a method for providing international calling services.

2. Description of Related Art

U.S. patent application No. 2003/0087639 to Barak is directed to a method and apparatus for making international cellular telephone calls. This method requires the use of dedicated switching equipment that introduces a number of problems. First, the dedicated switching equipment must be notified when the mobile device is brought into or taken out of the United States.

The Barak application also fails to teach any relationship or transaction with a foreign service provider. Because of this, Barak requires the use of new Direct Inward Dial (DID) numbers that are required to be provided or assigned by the foreign service provider for call forwarding. Use of the customer's existing foreign mobile number is not taught by Barak.

Barak also fails to teach access to mobile network operator systems. Because of this, the method of Barak would not allow the automated activation or suspension of service or porting of existing U.S. telephone numbers for additional services.

U.S. patent application No. 2004/053618 is directed to a method for informing a calling party and a roaming party that the roaming party is currently roaming. The application also discloses a potential method of allowing a decision and communication as to whether the roaming party or calling party would pay the roaming charges.

U.S. patent application No. 2004/142689 discloses a method of registering a roaming customer in a visiting network, and then carrying the call to/from the roaming customer by using a third network. However, the customer or mobile device in this application would still be roaming. The third network is disclosed as a private intranet backbone, as opposed to the public Internet. This application does not teach or suggest the elimination of “roaming” charges.

U.S. patent application No. 2004/152058 discloses a Mobile Virtual Network Operator (MVNO) Application Service Provider (ASP) concept providing a platform for customers to use a single mobile device to manage the selection and use of multiple service providers for various services. The application discloses an example of using one service provider for mobile calling, another for voicemail, yet another for calls after a certain time. The customer would be able to select each provider for each service through the envisioned platform.

U.S. patent application No. 2004/198362 discloses a concept of least cost routing for calls while roaming based on cost, using traditional roaming technology and agreements, and instituting a database for referencing costs of calls for determination of the least cost route, and then communicating the route instruction for call completion.

U.S. patent application No. 2005/192035 discloses the concept of a new type of Subscriber Identification Module (SIM) card that supports two different network operators simultaneously. This new SIM card provides two local numbers for the customer so that the customer would not be considered “roaming” in either network or country. The technology has intelligence so that the current location network is recognized and “roaming” is not established, then the billing information is gathered by the local network operator. The application also discloses the use of this concept across technologies (GSM, CDMA, and TDMA).

U.S. Pat. No. 6,006,094 discloses the introduction of a new prefix for routing international calls from the Public Switched Telephone Network (PSTN) to foreign mobile subscribers, allowing for different treatment of such calls than the current method of sending the call to the home country. In the case that the subscriber is roaming abroad, the current method would require a two legged international call (first to the home country, then to the roaming location). This requires incurring/charging two international call legs. The prefix theoretically would allow look-up of the current location, and then only a one-legged call.

U.S. Pat. No. 6,892,070 discloses a system for minimizing international roaming costs. This patent discloses a solution that utilizes a PBX in both the home location or country and the visiting location or country. The caller would have to inform the system that he/she is roaming. Calls to the customer's “universal number” would then go through the home PBX over a transmission mechanism/network between the PBXs, and then via local call to the callers mobile device. This traveling mobile device is envisioned to be a different one than the home device. Calls from the traveling mobile device would be carried in the same fashion, via the PBX network.

While the related art teaches various kinds of communications technologies, the related art fails to teach a method for providing cost effective international calling services. The related art also fails to teach or suggest the concept of using by-pass communications over low cost networks to avoid roaming charges. The related art also fails to teach or suggest a method for providing international calling and roaming services in a domestic nation to foreign service providers.

### SUMMARY OF THE INVENTION

A method for providing international calling services is disclosed. In one aspect, the invention includes the steps of preparing a mobile device for communication with a first network; exporting the mobile device to a foreign service provider located in a foreign country; receiving call records related to the usage of the mobile device in the United States; and sending the call records to the foreign service provider.

In another aspect, the first network is a wireless cellular network.

In another aspect, the mobile device is a cellular telephone.

In another aspect, the mobile device is a SIM card.

In another aspect, the step of preparing the mobile device for communication with the first network comprises the step of registering the mobile device with the first network.

In another aspect, the step of preparing the mobile device for communication with the first network comprises the step of obtaining a domestic telephone number associated with the first network.

In another aspect, the invention provides a method for assisting with international calls comprising the steps of preparing a mobile device for communication with a first network; exporting the mobile device to a foreign service provider located in a foreign country; receiving information related to an outgoing international call made by the mobile device; and routing the call to a second network in communication with a foreign network.

In another aspect, the foreign network is associated with the foreign service provider.

In another aspect, the outgoing international call is routed to a second service provider via a telephone number.

In another aspect, the telephone number is a toll free number.

In another aspect, the telephone number is a direct inward dial number.

In another aspect, the telephone number is a local telephone number.

In another aspect, the second network is a packet switched network.

In another aspect, the packet switched network is the Internet.

In another aspect, the international call is routed to the foreign network using voice over Internet protocol.

In another aspect, the invention provides a method for assisting with international calls comprising the steps of preparing a mobile device for communication with a first network; exporting the mobile device to a foreign service provider located in a foreign country; receiving information related to an incoming international call made to the mobile device; and routing the call to the first network for delivery to the mobile device.

In another aspect, the information related to the incoming international call is received from the foreign service provider and includes identifying information associated with the mobile device.

In another aspect, the information related to the incoming international call is received over a network using voice over internet protocol.

In another aspect, the first network is a wireless cellular network operated by a second service provider.

In another aspect, the call records are received from the second service provider.

In another aspect, the call records are sent to the foreign service provider.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a flow diagram of a preferred embodiment of a method for providing international calling services;

FIG. 2 is a schematic diagram of a preferred embodiment of a mobile device;

FIG. 3 is a schematic diagram of a preferred embodiment of various foreign and domestic network resources;

FIG. 4 is a flow diagram of a preferred embodiment of a method for assisting a mobile device;

FIG. 5 is a flow diagram of a preferred embodiment of a method for assisting a mobile device receive incoming international calls; and

FIG. 6 is a flow diagram of a preferred embodiment of a method for assisting a mobile device in making outgoing international calls.

### DETAILED DESCRIPTION OF THE PREFERRED EMBODIMENTS

Principles and teachings of the present invention can be applied to many different contexts and situations. The following description provides one operating or deployment example where the United States serves as the domestic or local nation, and another country serves as the foreign nation. However, it should be kept in mind that principles of the invention can be applied situations where any nation is considered the domestic or local nation and any other nation is considered the foreign nation. The following exemplary disclosure was selected for clarity.

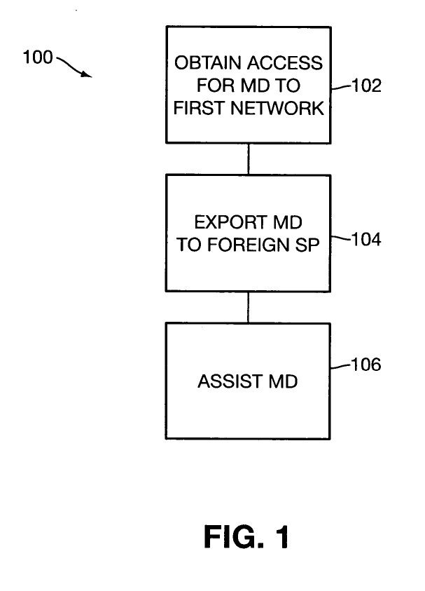

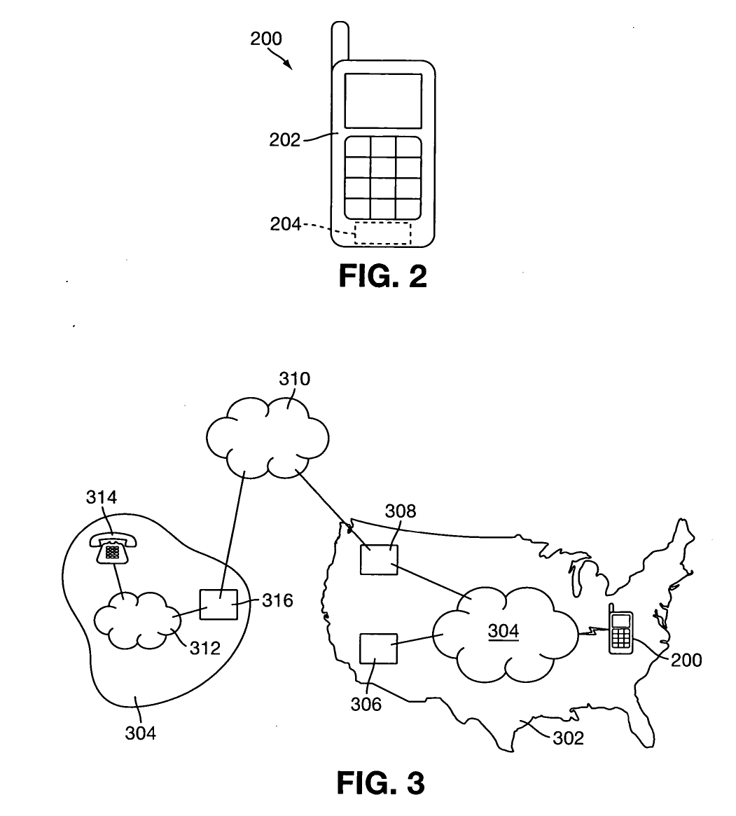

Referring to FIGS. 1-3, FIG. 1 is a flow diagram of a preferred embodiment of a method 100 for providing international calling services, and FIGS. 2 and 3 are schematic diagrams of various exemplary network elements. FIG. 2 is a schematic diagram of a preferred embodiment of mobile device 200. The term “mobile device” used in this specification and claims means any device that can facilitate communication with any network. Two different kinds of mobile devices can be observed in FIG. 2. Mobile device 200 can come in the form of mobile equipment 202 or a data device 204. In some embodiments, mobile equipment 202 can be a wireless cellular telephone or wireless handset. However, in other embodiments, mobile equipment 202 can be a handheld computer, like a Personal Data Assistant, a portable computer, like a notebook computer, or any other device that can communicate with a wireless network either through voice or data. Data device 204 can be any device that facilitates or assists another device in communicating with a wireless network. In a preferred embodiment, data device 204 is a Subscriber Identifying Module (SIM) card.

Other network elements can be observed in FIG. 3. First network 304 can provide communications services to domestic nation 302. In this example, domestic nation 302 is the United States. In a preferred embodiment, first network 304 is a wireless network. First service provider 306 manages and operates first wireless network 304. First service provider 306 can be referred to as a wireless network operator. Currently, in the United States, Verizon, Cingular, and Sprint are examples of wireless network operators.

In addition to first service provider 306, a second service provider 308 can also interact with first wireless network 304. In the embodiment shown in FIG. 3, second service provider 308 has an agreement with first service provider 306 to access first network 304 and provide services on first network 304. Second service provider 308 can be referred to as a Mobile Virtual Network Operator (MVNO).

In the embodiment shown in FIG. 3, second service provider 308 can communicate with foreign service provider 316 located in foreign country 304. In the embodiments shown in FIG. 3, foreign service provider 316 operates or interacts with foreign network 312. Foreign network 312 can provide communications service to one or more foreign telephones 314. Preferably, a second network 310 is used to conduct those international communications.

Given this exemplary operating context and referring to FIGS. 1-3, FIG. 1 is a flow diagram of a preferred embodiment of a method 100 for providing international calling services. Preferably, method 100 begins with step 102 where second service provider 308 obtains access for mobile device 200 to communicate with first network 304. In step 102, second service provider 308 can configure either mobile equipment 202 or data device 204 to communicate with or operate in first network 304.

Preferably, first network 304 is a wireless network and mobile device 200 communicates wirelessly with first network 304. Returning to FIG. 1, the next step 104 of method 100 is to export mobile device 200 to foreign service provider 316. As disclosed above, foreign service provider 316 is located in a foreign country 304. Foreign service provider 316 then provides mobile device 200 to users who are planning to travel to domestic nation 302. After the user obtains mobile device 200 from foreign service provider 316, The user then travels to domestic nation 302 with mobile device 200. Preferably, as shown in step 106, second service provider 308 assists mobile device 200 in many ways after mobile device 200 has returned to the United States.

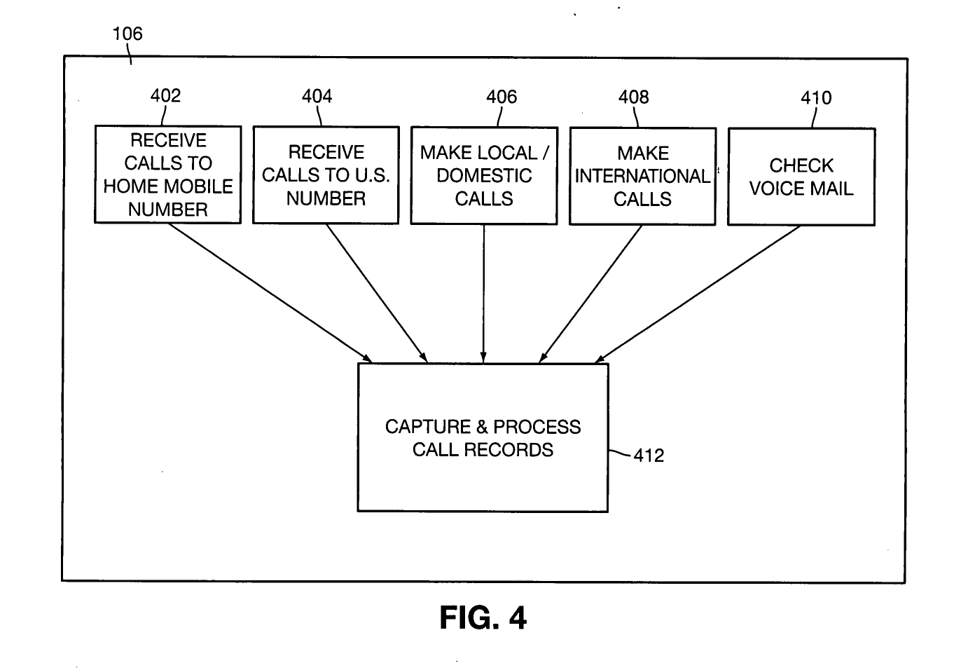

FIG. 4 is a preferred embodiment of a flow diagram of step 106, where second service provider 308 assists mobile device 200. In other words, FIG. 4 is an enlargement of step 106 showing the various processes and methods that can occur in step 106 of FIG. 1. In the embodiment shown in FIG. 4, second service provider 308 can assist mobile device 200 in many different ways. In step 402, second service provider 308 can assist mobile device 200 in receiving calls made to a home mobile number.

In step 404, second service provider 308 can assist mobile device 200 in receiving domestic calls made in domestic nation 302. In step 406, second service provider 308 can assist mobile device 200 in making local or domestic telephone calls. In step 408, second service provider 308 can assist mobile device 200 in making international calls. And in step 410, second service provider 308 can assist mobile device 200 in checking voicemail. After those functions have been carried out, second service provider 308 can capture and process call records in step 412. All of the steps above are optional and need not be used in every embodiment. In some embodiments, one or more steps are used to assist mobile device 200, in other embodiments, all of the steps shown in FIG. 4 are used to assist mobile device 200.

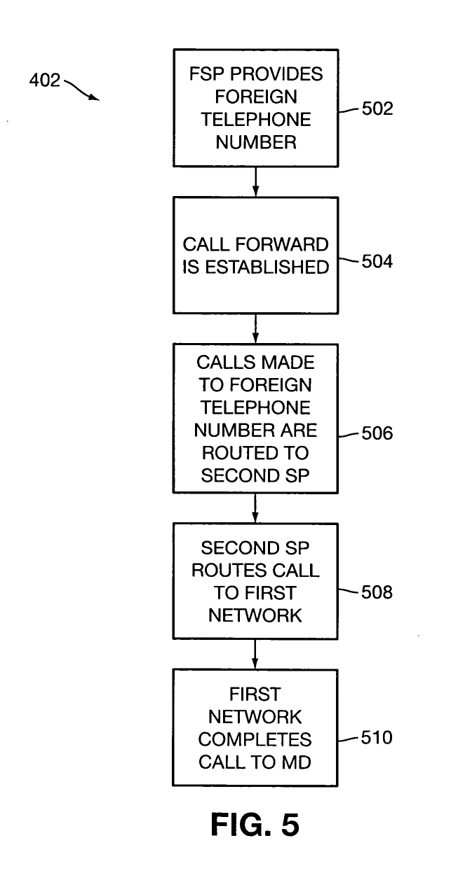

FIG. 5 is a flow diagram of a preferred embodiment of a method for assisting mobile device 200 to receive internationally originated calls. Method 402 preferably begins with step 502 where foreign service provider 316 provides a foreign telephone number. This foreign telephone number can be a local telephone call within foreign country 304. In other words, if foreign telephone 314 were to dial the foreign telephone number in foreign country 304, the call would be a local call and, in some cases, no tolls or long-distance charges would be assessed.

In step 504, a call-forwarding process is established. In some embodiments, foreign service provider 316 establishes a call-forwarding feature so that calls made to the foreign telephone number are forwarded to mobile device 200.

In step 506, calls made to the foreign telephone number are routed by foreign service provider 316 to second service provider 308. Preferably, second network 310 is used to forward the call from foreign service provider 316 to second service provider 308. Second network 310 can be any type of network. In some embodiments, second network 310 is a traditional voice network, for example, PSTN or TDM. If second network 310 is a traditional voice network, the calls can be routed or switched in a conventional manner.

In other embodiments, second network 310 can be an international public network. In some cases, this international network can be a low-cost network and in some embodiments, second network 310 can be the internet. In embodiments where second network 310 is the internet, voice over internet protocol (VoIP) can be used to send voice calls from foreign service provider 316 to second service provider 308 located in domestic nation 302.

Unlike related art systems that use dedicated switching equipment, the present method is preferably different. Preferably, general call forwarding occurs to the US mobile number through their existing foreign mobile service. In some cases, second service provider 308 does not participate in providing the call forwarding service. However, in embodiments where second service provider 308 does participate in forwarding calls, it would typically be routed (via a router) by foreign service provider 316 via the public internet (using VoIP) to second service provider 308 for termination via PSTN or VoIP and not usually directly to first service provider 306.

After second service provider 308 has received the incoming international call from foreign service provider 316, second service provider preferably routes the call to first network 304 as shown in step 508. First network receives the call from second service provider 308 and completes the call to mobile device 200.

In an alternative embodiment, foreign service provider 316 can route incoming calls for mobile device 200 directly to first network 304 by-passing second service provider 308. In this embodiment, second service provider 308 may provide instructions to foreign service provider 316, including the domestic telephone number of mobile device 200 in domestic nation 302 and SIM information. Foreign service provider 316 can then use this information to forward calls directly to first network 304. In this embodiment, second service provider 308 can still collect information related to usage even though it does not participate in forwarding the call to mobile device 200.

By using the method shown in FIG. 5, expensive international roaming and international long-distance fees or tolls can be avoided. If foreign telephone 314 were to call the telephone number assigned by foreign service provider 316 in foreign country 304, the call would be a domestic call that could be either a toll free local call or a domestic long distance call with domestic long distance charges being applied. However, the call would not be an international call with international long distance charges being applied. Using the method shown in FIG. 4, international long distance charges and international roaming charges can be avoided.

Returning to FIG. 4, in step 404, second service provider 308 can provide a domestic telephone number associated with mobile device 200. In cases where the calling party is located in the domestic nation 302 and makes a call to the domestic telephone number associated with mobile device 200, those domestic calls are preferably managed by first network 304. In some cases those calls are managed exclusively by first network 304 without the participation of second service provider 308 or second network 310.

Similarly, in step 406, if mobile device 200 is located in domestic nation 302 and wishes to call a called party located in domestic nation 302, those domestic calls can be managed by first network 304. In some embodiments, those domestic calls are managed exclusively by first network 304 and second service provider 308 does not participate in the completion of those calls.

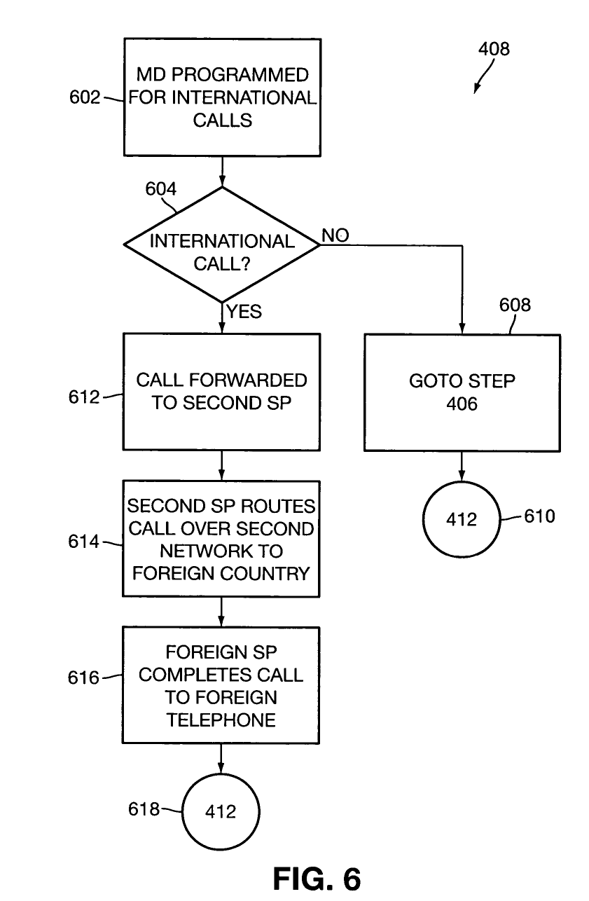

In step 408, second service provider 308 can assist mobile device 200 in making outgoing international calls. A preferred embodiment of a method for assisting mobile device 408 in making international calls is shown in FIG. 6. In step 602, the mobile device 200 is preferably programmed for international calls. Preferably mobile device 200 includes information that directs or forwards all international calls to second service provider 308.

This can be done in many ways. In a preferred embodiment, all international calls or all calls with an international dialing prefix are routed to a telephone number associated with second service provider 308. In a preferred embodiment, this telephone number associated with second service provider 308 is a toll-free number, for example, a 1-800 or a 1-888. In other embodiments, it is also possible to route the calls to second service provider 308 using a Direct Inward Dial (DID) number or a local telephone number.

In step 604, mobile device 200 determines if an international or domestic telephone call is being made. If a domestic phone call is being made, in the example shown in FIG. 3, the called party is located within the United States 302, then method 408 goes to step 608 where the process returns to step 406 of FIG. 4. As disclosed above, step 406 is the procedure for making domestic telephone calls.

Returning to step 604, in cases where it has been detected that an international call is made, method 408 goes to step 612 where the call is forwarded to second service provider 308. In step 614, second service provider 308 routes the call to foreign service provider 316. Preferably, a second network 310 is used to send the call for foreign service provider 316.

As disclosed above, second network 310 can be any type of network. In some embodiments, second network 310 is a traditional voice network, for example, PSTN or TDM. If second network 310 is a traditional voice network, the calls can be routed or switched in a conventional manner.

In other embodiments, second network 310 can be an international public network. In some cases, this international network can be a low-cost network and in some embodiments, second network 310 can be the internet. In embodiments where second network 310 is the internet, voice over internet protocol (VoIP) can be used to send voice calls to foreign service provider 316.

Unlike related art systems that require the use of a dedicated switching platform for carrying the international calls, a software application is preferably used to route the call to foreign service provider 316. Preferably, a software application is used to authenticate and authorize mobile device 200 prior to completing or routing the international call. After authentication and authorization have been successful, the call is then routed either via a VoIP gateway or a switching platform; such switching platform would not be “dedicated” to this service or application.

In step 616, foreign service provider 316 receives the incoming call from second network 310 and completes the call to foreign telephone 314. Using the method shown in FIG. 6, mobile device 200 is able to make international calls while avoiding expensive international roaming and international long-distance rates.

Second service provider 308 can also assist mobile device 200 in checking voicemail in step 410. In some embodiments, the traveler's home voicemail can be checked. In the embodiment shown in FIG. 3, the traveler's home voicemail would be associated with, and likely hosted by, foreign service provider 316.

To assist in checking home voicemail, mobile device 200 can include provisions to rapidly access home voicemail. In some embodiments, a voicemail button on mobile device 200 is programmed to access home voicemail, in other embodiments, a contact telephone number on a directory in mobile device 200 is programmed to access home voicemail.

In any case, the user provides instructions to mobile device 200 to access home voicemail. Mobile device 200 then contacts second service provider 308. This can be done in a manner similar to the international outgoing call routine described above, where a predetermined telephone number, like a 1-800 number is programmed into mobile device 200. Once second service provider 308 receives a request for home voicemail access, second service provider 308 contacts foreign service provider 316. Preferably, second network 310 is used to conduct these communications between second service provider 308 and foreign service provider 316.

Preferably, by using second network 310, second service provider 308 can help mobile device 200 communicate directly with foreign service provider 316, which can allow mobile device 200 to access and interact with its associated voicemail account. Using this method, a traveling user who is currently in another country, can access his or her home voicemail account located in their home country with incurring expensive international roaming or international long distance charges.

An optional step that can be used in conjunction with any of the steps 402-410 is a step of capturing and processing call records in step 412. In this step, second service provider 308 receives information related to the usage of mobile device 200. In one embodiment, second service provider 308 receives this information from resources, such as switches or servers, that it maintains or are otherwise within its custody and control. In another embodiment, second service 308 receives detailed call records from first service provider 306. In any case, second service provider 308 can then send this information to foreign service provider 312, who can then prepare a bill for the customer.

Using principles of the present invention, a foreign service provider can be provided with the turnkey ability to offer alternative international mobile roaming solutions to their existing subscribers who travel abroad to the United States. Foreign service providers would have the ability to give their existing customers an economical mobile service for making and receiving calls, as well as checking voice mail, while traveling outside of their home country and to another country, for example, the United States. This provides an alternative to international roaming. The foreign service provider can not only offer this to their customers as an add-on service to increase customer loyalty and retention, but also as a means to increase usage, revenue and profits.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A method for providing international calling service comprising the steps of:
preparing a mobile device for communication with a first network;
exporting the mobile device to a foreign service provider located in a foreign country;
receiving call records related to the usage of the mobile device in the United States; and
sending the call records to the foreign service provider.

2. The method according to claim 1, wherein the first network is a wireless cellular network.

3. The method according to claim 1, wherein the mobile device is a cellular telephone.

4. The method according to claim 1, wherein the mobile device is a SIM card.

5. The method according to claim 1, wherein the step of preparing the mobile device for communication with the first network comprises the step of registering the mobile device with the first network.

6. The method according to claim 1, wherein the step of preparing the mobile device for communication with the first network comprises the step of obtaining a domestic telephone number associated with the first network.

8. A method for assisting with international calls comprising the steps of:
preparing a mobile device for communication with a first network;
exporting the mobile device to a foreign service provider located in a foreign country;
receiving information related to an outgoing international call made by the mobile device; and
routing the call to a second network in communication with a foreign network.

9. The method according to claim 8, wherein the foreign network is associated with the foreign service provider.

10. The method according to claim 8, wherein the outgoing international call is routed to a second service provider via a telephone number.

11. The method according to claim 10, wherein the telephone number is a toll free number.

12. The method according to claim 10, wherein the telephone number is a direct inward dial number.

13. The method according to claim 10, wherein the telephone number is a local telephone number.

14. The method according to claim 8, wherein the second network is a packet switched network.

15. The method according to claim 14, wherein the packet switched network is the Internet.4

16. The method according to claim 14, wherein the international call is routed to the foreign network using voice over Internet protocol.

17. A method for assisting with international calls comprising the steps of:
preparing a mobile device for communication with a first network;
exporting the mobile device to a foreign service provider located in a foreign country;
receiving information related to an incoming international call made to the mobile device; and
routing the call to the first network for delivery to the mobile device.

18. The method according to claim 17, wherein the information related to the incoming international call is received from the foreign service provider and includes identifying information associated with the mobile device.

19. The method according to claim 18, wherein the information related to the incoming international call is received over a network using voice over internet protocol.

20. The method according to claim 17, wherein the first network is a wireless cellular network operated by a second service provider.

21. The method according to claim 17, wherein call records are received from the second service provider.

22. The method according to claim 21, wherein the call records are sent to the foreign service provider.
